(19) United States
(12) Patent Application Publication
(10) Pub. No.: US 2019/0240105 A1
(43) Pub. Date: Aug. 8, 2019

(54) MULTIDIRECTIONAL SUSPENSION DEVICE FOR WALKING EXERCISE

(71) Applicant: Boo Hwan JUNG, Busan (KR)

(72) Inventor: Boo Hwan JUNG, Busan (KR)

(21) Appl. No.: 16/318,367

(22) PCT Filed: Jul. 20, 2017
(86) PCT No.: PCT/KR2017/007856

§ 371 Date: Jan. 17, 2019

(30) Foreign Application Priority Data
Jul. 25, 2016 (KR) 10-2016-0094032

(51) Int. Cl. A61H 3/00

(52) U.S. Cl. CPC A61H 3/008; A61H 2201/1652; A61H 2203/0487; A61H 2003/007; A61H 2201/0119; A61H 2203/0406

(57) ABSTRACT

A multidirectional suspension device for walking exercises, includes: a center support; a first link unit which is coupled to the center support and rotated about a first axis or vertically moved; and a second link unit which is linked with the first link unit, rotates about a second axis or slides in a longitudinal direction thereof, and has one side to which a safety belt for the suspension device worn by a user is coupled, wherein the user is suspended from the multidirectional suspension device and performs exercises in multiple directions by the first axis and the second axis.

### FIELD OF THE DISCLOSURE

The present disclosure relates to a multidirectional suspension device for walking exercises, and more particularly, to a multidirectional suspension device for walking exercises that enables a patient to perform walking exercises in multiple directions by using a link structure.

### BACKGROUND OF THE DISCLOSURE

As a document in the related art, Korean Utility Model Registration No. 20-0446186 discloses a self-suspended walking assistance device for rehabilitation. The self-suspended walking assistance device for rehabilitation disclosed in the document in the related art cannot deviate from a rail and thus a patient inevitably moves along the rail, and as a result, the motion of the patient is restrictive and monotonous.

### DOCUMENT OF RELATED ART

### Patent Documents

Korean Utility Model Registration No. 20-0446186 (Sep. 25, 2009)

Korean Patent No. 10-1664901 (Oct. 5, 2016)

Korean Patent Application Laid-Open No. 10-2016-0057099 (May 23, 2016)

Korean Patent Application Laid-Open No. 10-2015-0104899 (Sep. 16, 2015)

Korean Patent No. 10-1741980 (May 25, 2017)

### SUMMARY

Therefore, the present disclosure has been made in an effort to solve the aforementioned problem, and an object of the present disclosure is to enable a patient to perform walking exercises in multiple directions such as forward, rearward, leftward, rightward, circular, and diagonal directions.

However, the objects of the present disclosure are not limited to the aforementioned object, and other objects, which are not mentioned above, may be clearly understood by those skilled in the art from the following descriptions.

The aforementioned object of the present disclosure may be achieved by providing a multidirectional suspension device for walking exercises of a patient, including: a center support; a first link unit which is coupled to the center support and rotated about a first axis or vertically moved; and a second link unit which is linked with the first link unit, rotates about a second axis or slides in a longitudinal direction thereof, and has one side to which a safety belt for the suspension device worn on a patient's body is coupled, in which the patient is suspended from the multidirectional suspension device and may perform exercises in multiple directions by the first axis and the second axis (see FIG. 1).

In addition, the first axis is a central axis of the center support, and the second axis is a coupling axis between the first link unit and the second link unit (see FIG. 1).

In addition, the first axis is spaced apart from a central axis of the center support at a predetermined distance, and the second axis is a coupling axis between the first link unit and the second link unit (see FIG. 9).

In addition, the first link unit includes: a first link arm drive unit which is provided on the center support and rotates the first link arm about the first axis or vertically moves the first link arm; and a first link arm which is coupled at one side thereof to the first link arm drive unit, the second link unit includes: a link coupling unit which is coupled at the other side to the first link arm; and a second link arm which is coupled to be rotatable relative to the link coupling unit, and the safety belt for the suspension device is coupled to an end portion of the second link arm (see FIGS. 1 and 3).

In addition, the multidirectional suspension device further includes an outer support which is coupled to be spaced apart from the center support at a predetermined distance in a circumferential direction, in which the first link unit includes: a first link arm drive unit which is provided on the outer support and rotates the first link arm about the first axis or vertically moves the first link arm; and a first link arm which is coupled at one side thereof to the first link arm drive unit, the second link unit includes: a link coupling unit which is coupled at the other side to the first link arm; and a second link arm which is coupled to be rotatable relative to the link coupling unit, and the safety belt for the suspension device is coupled to an end portion of the second link arm (see FIGS. 9 and 15).

In addition, the first link arm or the second link arm is slidably folded or unfolded in a longitudinal direction thereof (see FIG. 2).

In addition, the first link unit further includes a first link arm stopper which is provided on the first link arm drive unit and restricts a rotation angle of the first link arm.

In addition, the second link unit further includes a second link arm stopper which is provided on the link coupling unit and restricts a rotation angle of the second link arm (see FIGS. 6 and 7).

In addition, the second link arm stopper restricts an interior angle between the first link arm and the second link arm so that the interior angle does not exceed 180 degrees (see FIGS. 6 and 7).

In addition, the first link arm and the second link arm are formed in a straight shape when the first link arm drive unit vertically moves the first link arm, and the first link arm and the second link arm are formed in a curved shape when the first link arm drive unit rotates the first link arm (see FIGS. 3 and 13).

In addition, a central axis of the curved shape of the first link arm and a central axis of the curved shape of the second link arm are formed on the same plane or different planes (see FIG. 13).

In addition, the first link unit further includes an upper support or a lower support for dispersing a patient's load applied to the first link arm, and the second link unit further includes an upper support for dispersing the patient's load applied to the second link arm (see FIG. 9).

In addition, the multidirectional suspension device includes: a first suspension device which includes the first link unit and the second link unit and is provided in a first direction; and a second suspension device which is provided in a second direction different from the first direction, in which multiple patients may simultaneously perform walking exercises.

In addition, the center support is supported by at least any one of an upper support plate and a lower support plate (see FIGS. 17 to 19).

According to the present disclosure as described above, two or more patients may simultaneously perform walking exercises, the patients may perform the exercises in multiple directions because a walking route is not defined when the patients perform the walking exercises, and an area available for walking exercises may be increased or decreased.

### BRIEF DESCRIPTION OF THE DRAWINGS

The following drawings attached to the present specification illustrate exemplary embodiments of the present disclosure and serve to further understand the technical spirit of the present disclosure together with the detailed description of the present disclosure, and the present disclosure should not be interpreted as being limited to the items illustrated in the drawings.

FIG. 1 is a view illustrating a state in which only one suspension device part (a first link arm drive unit is configured as a rotation drive unit) of a multidirectional suspension device for walking exercises of a patient according to a first exemplary embodiment of the present disclosure is provided in one direction.

FIG. 2 is a view illustrating a state in which a second link arm according to the first exemplary embodiment of the present disclosure slides in a longitudinal direction thereof.

FIGS. 3 and 4 are views illustrating a state in which the first link arm drive unit according to the first exemplary embodiment of the present disclosure is implemented as a vertical drive unit.

FIG. 5 is a view illustrating a state in which suspension device parts of a multidirectional suspension device for walking exercises of a patient (a first axis of a suspension device part is on a center support and a first link arm drive unit is configured as a rotation drive unit) according to a second exemplary embodiment of the present disclosure are provided in three directions.

FIGS. 6 and 7 are views for explaining functions of a first link arm stopper and a second link arm stopper.

FIG. 8 is a view illustrating a walkable area the multidirectional suspension device for walking exercises of a patient according to the second exemplary embodiment of the present disclosure.

FIGS. 9 and 10 are views illustrating a state in which a first axis is on an outer support as a suspension device part (a first link arm drive unit is configured as a rotation drive unit) of a multidirectional suspension device for walking exercises of a patient according to a third exemplary embodiment of the present disclosure has the outer support.

FIG. 11 is a view illustrating a walkable area of a multidirectional suspension device for walking exercises of a patient according to the third exemplary embodiment of the present disclosure.

FIG. 12 is a view illustrating a state in which a second link arm according to the third exemplary embodiment of the present disclosure slides in a longitudinal direction thereof.

FIGS. 13 and 14 are views illustrating a state in which a first link arm and a second link arm according to the third exemplary embodiment of the present disclosure each have a curved shape.

FIGS. 15 and 16 are views illustrating a state in which a first link arm drive unit according to a fourth exemplary embodiment of the present disclosure is configured as a vertical drive unit.

FIGS. 17 to 19 are views illustrating a state in which the multidirectional suspension device for walking exercises of a patient according to the exemplary embodiment of the present disclosure is installed on a ceiling and a floor.

### DESCRIPTION OF MAIN REFERENCE NUMERALS OF THE DRAWINGS

10: Safety belt for suspension device
11: Connecting member
20: Suspension device for walking exercise assistance device
21: Belt latch
30: Center support
40: Upper support plate
50: Lower support plate
100: Multidirectional suspension device for walking exercises of patient
110: Center support
120: First link unit
121: First link arm rotating unit
122: First upper support rotating unit
123: First lower support rotating unit
124: First link arm
125: First upper support
126: First lower support
130: Second link unit
131: Link coupling unit
134: Second link arm
135: Second upper support
141: First link arm vertical drive unit
144: First link arm
151: Link coupling unit
154: Second link arm
155: Second upper support
200: Multidirectional suspension device for walking exercises of patient
210: Center support
220: First suspension device part
221: First link arm rotating unit (first link unit)
223: First lower support rotating unit
224: First link arm
225: First lower support
226: Link coupling unit (second link unit)
227: Second link arm
228: Second upper support
230: Second suspension device part
231: First link arm rotating unit (first link unit)
233: First lower support rotating unit
234: First link arm
235: First lower support
236: Link coupling unit (second link unit)
237: Second link arm
238: Second upper support
240: Third suspension device part
241: First link arm rotating unit (first link unit)
243: First lower support rotating unit
244: First link arm
245: First lower support
246: Link coupling unit (second link unit)
247: Second link arm
248: Second upper support
300: Multidirectional suspension device for walking exercises of patient
310: Center support
311: First outer support
312: Second outer support
313: Third outer support
320: First suspension device part
321: First link arm rotating unit (first link unit)
322: First upper support rotating unit
323: First lower support rotating unit
324: First link arm
325: First upper support
326: First lower support
327: Link coupling unit (second link unit)
328: Second link arm
329: Second upper support
330: Second suspension device part
331: First link arm rotating unit (first link unit)
332: First upper support rotating unit
333: First lower support rotating unit
334: First link arm
335: First upper support
336: First lower support
337: Link coupling unit (second link unit)
338: Second link arm
339: Second upper support
340: Third suspension device part
341: First link arm rotating unit (first link unit)
342: First upper support rotating unit
343: First lower support rotating unit
344: First link arm
345: First upper support
346: First lower support
347: Link coupling unit (second link unit)
348: Second link arm
349: Second upper support
400: Multidirectional suspension device for walking exercises of patient
410: Center support
411: First outer support
412: Second outer support
413: Third outer support
420: First suspension device part
421: First link arm vertical drive unit (first link unit)
424: First link arm
427: Link coupling unit (second link unit)
428: Second link arm
429: Second upper support
430: Second suspension device part
431: First link arm vertical drive unit (first link unit)
434: First link arm
437: Link coupling unit (second link unit)
438: Second link arm
439: Second upper support
440: Third suspension device part
441: First link arm vertical drive unit (first link unit)
444: First link arm
447: Link coupling unit (second link unit)
448: Second link arm
449: Second upper support

### DETAILED DESCRIPTION

Hereinafter, exemplary embodiments of the present disclosure will be described with reference to the drawings. In addition, the exemplary embodiment described below does not unfairly limit the contents of the present disclosure disclosed in the claims, and all of the constituent elements described in the exemplary embodiment are not essential as technical solutions of the present disclosure. In addition, the descriptions of the related art and configurations obvious to those skilled in the art may be omitted, and the reference will be sufficiently made to the omitted descriptions of constituent elements (methods) and functions without departing from the technical spirit of the present disclosure.

A multidirectional suspension device for walking exercises of a user according to the present disclosure is a device that assists the user in walking in multiple directions such as forward, rearward, leftward, rightward, circular, and diagonal directions. However, the user is considered as a patient in the present specification for convenience of description, but the user is not necessarily limited to being the patient. Hereinafter, multidirectional suspension devices for walking exercises of a patient according to the present disclosure will be described in detail with reference to the accompanying drawings.

### First Exemplary Embodiment

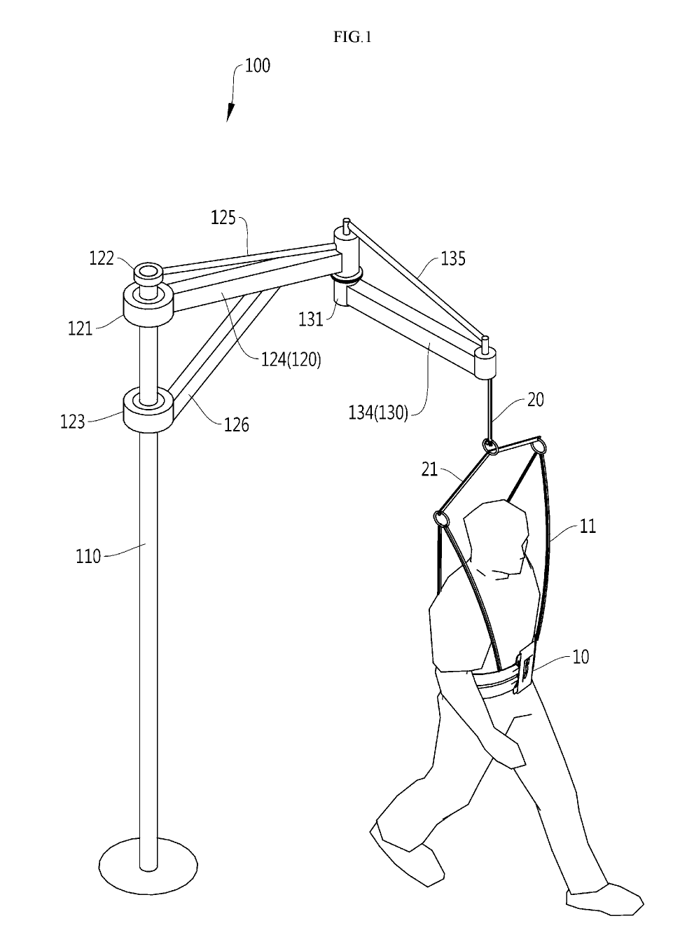

As illustrated in FIGS. 1 to 4, a multidirectional suspension device 100 for walking exercises of a patient according to a first exemplary embodiment of the present disclosure has a center support 110, a first link unit 120, and a second link unit 130 and assists a patient in performing walking exercises. In this case, as illustrated in FIG. 1, the multidirectional suspension device 100 further has a safety belt 10 for the suspension device and a suspension device 20 for a walking exercise assistance device. The safety belt 10 for the suspension device is worn on the patient's body and may be implemented referring to the contents disclosed in Korean Patent Application No. 10-2014-0113363 or 10-2014-0157861 filed in the name of the present applicant without departing from the technical spirit of the present disclosure. In addition, the suspension device 20 for the walking exercise assistance device is coupled to an end portion of a second link arm 134 and a belt latch 21, and the belt latch 21 is coupled to the safety belt 10 for the suspension device by a connecting member 11. In this case, the suspension device 20 for the walking exercise assistance device, the belt latch 21, and the connecting member 11 may be implemented referring to the contents disclosed in Korean Patent Application No. 10-2014-0026838 or 10-2015-0030469 filed in the name of the present applicant without departing from the technical spirit of the present disclosure.

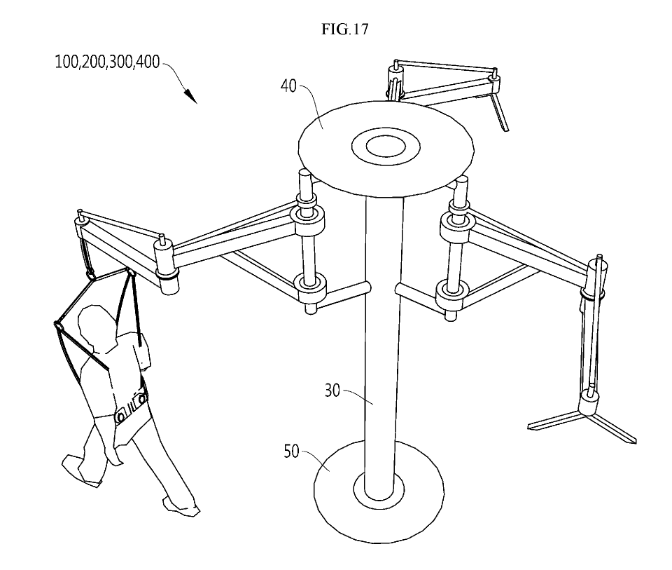

FIGS. 1 to 4 are views illustrating a state in which the center support 110 defines a first axis. As illustrated in FIGS. 17 to 19, the center support 110 illustrated in FIG. 1 may be supported and fixed at an upper side or a lower side thereof. A first link arm rotating unit 121, an upper support rotating unit 122, and a lower support rotating unit 123 are provided on and coupled to the center support 110. In this case, the center support 110 defines the first axis. That is, a first link arm 124 is rotated about the first axis of the center support 110.

The first link unit 120 includes the first link arm rotating unit 121, the first upper support rotating unit 122, the first lower support rotating unit 123, the first link arm 124, a first upper support 125, and a first lower support 126. The first link arm rotating unit 121 rotates the first link arm 124 about the first axis of the center support 110. The first link arm rotating unit 121 may be specified by including a body 121 having a circular cross section and a bearing disposed in the body 121. Each of the first upper support rotating unit 122 and the first lower support rotating unit 123 may also be specified by including a body and a bearing, and each of the first upper support rotating unit 122 and the first lower support rotating unit 123 is provided on the axis of the center support 110. The first upper support rotating unit 122 is provided at an upper side, and the first link arm rotating unit 121 and the first lower support rotating unit 123 are sequentially provided at a lower side on the axis of the center support 110. The first link arm 124 is coupled to the body 121 of the first link arm rotating unit and a link coupling unit 131 to be described below, and the first link arm 124 has an approximately rectangular shape. The first lower support 126 is coupled to the body 123 of the first lower support rotating unit and a lower end surface of the first link arm 124 to disperse (or support) the patient's load. The first upper support 125 is coupled to the body 122 of the first upper support rotating unit and the link coupling unit 131 to be described below or may be coupled to the first link arm 124. However, FIG. 1 illustrates that the first upper support 125 is coupled to the link coupling unit 131, but the first upper support 125 may be coupled to the first link arm 124. Each of the first upper support 125 and the first lower support 126 has an approximately rectangular shape and disperses the patient's load. The first upper support 125 rotates simultaneously when the first link arm 124 is rotated about the first axis by the first upper support rotating unit 122. The first lower support 126 also rotates simultaneously when the first link arm 124 is rotated about the first axis by the first lower support rotating unit 123.

The second link unit 130 includes the link coupling unit 131, the second link arm 134, and a second upper support 135. The link coupling unit 131 links the first link arm 124 and the second link arm 134. In addition, the link coupling unit 131 couples the second link arm 134 so that the second link arm 134 rotates about an axis. Therefore, the link coupling unit 131 functions as a second axis. In order to disperse (or support) a load applied to the second link arm 134, the second upper support 135 is coupled to the link coupling unit 131 and one end portion of the second link arm 134. Any one of the link coupling unit 131 and the end portion of the second link arm 134, to which the second upper support 135 is coupled, may be coupled to be rotated about an axis so that the second link arm 134 rotates about the second axis. Therefore, the second upper support 135 also rotates about the second axis simultaneously when the second link arm 134 is rotated about the second axis. The second link arm 134 has a rectangular shape, and the link coupling unit 131 has a cylindrical shape. The suspension device 20 for the walking exercise assistance device is coupled at a lower side of the end portion of the second link arm 134.

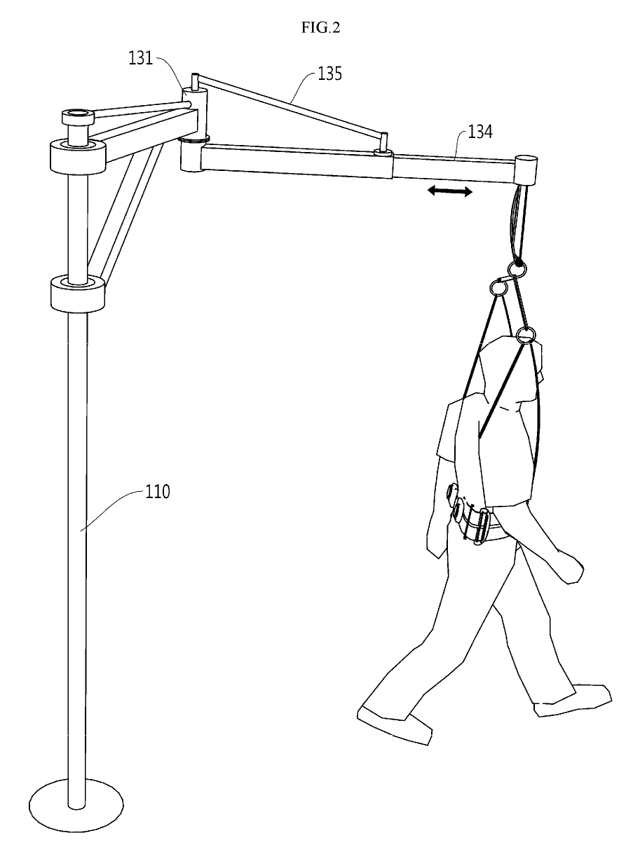

As illustrated in FIG. 2, the second link arm 134 may be slidably folded or unfolded in a longitudinal direction thereof. A length of the second link arm 134 is adjusted as the second link arm 134 slides in the longitudinal direction thereof, such that a movement radius of the patient may be adjusted. However, although not illustrated in the drawings, the first link arm 124 may also slide in a longitudinal direction thereof. The longitudinal sliding movements of the first and second link arms may be automatically controlled by an actuator, and the first and second link arms may be manually slid by force of the patient.

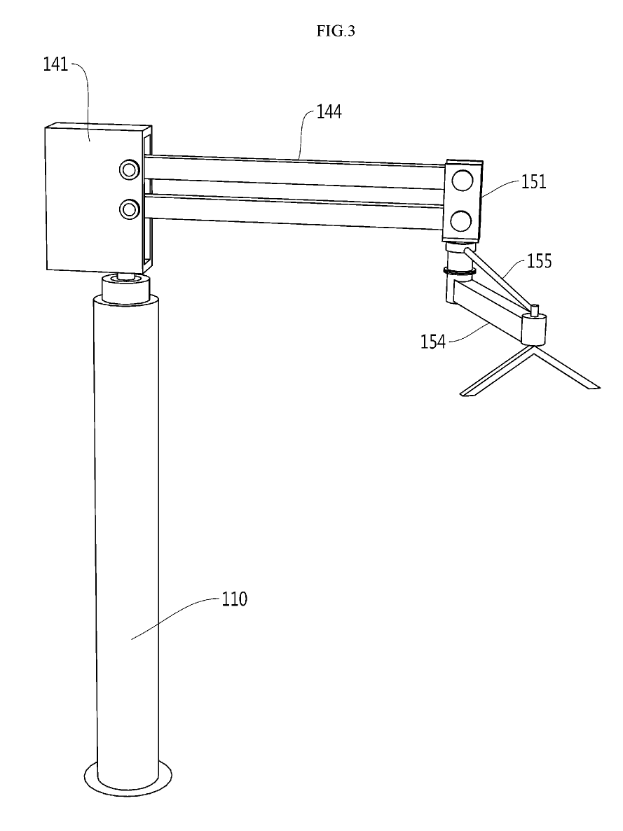

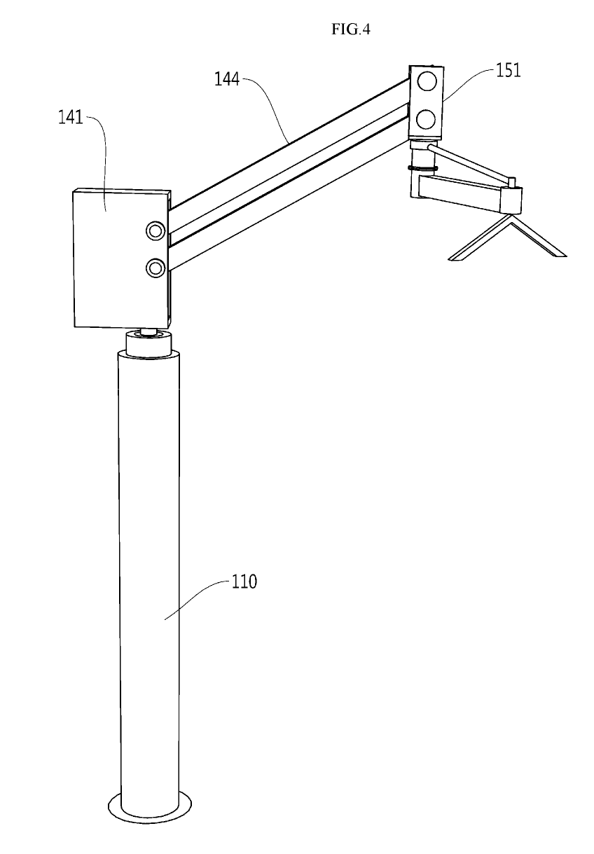

As illustrated in FIG. 3, a first link arm vertical drive unit 141 is provided on the axis of the center support 110. That is, while FIG. 1 illustrates that the first link arm rotating unit 121 is provided on the axis of the center support 110, FIG. 3 illustrates that the first link arm vertical drive unit 141 is provided on the axis of the center support 110. The first link arm vertical drive unit 141 is operated by an actuator to raise or lower the first link arm 144, as illustrated in FIG. 4. The patient initially wears the safety belt 10 for the suspension device while stooping slightly, and the first link arm vertical drive unit 141 is operated to raise the first link arm 144 to allow the patient to stand upright after the patient wears the safety belt 10. In addition, because the patients may have different heights, the first link arm vertical drive unit 141 may be operated to adjust the first link arm 144 adapted to the patient's height. The actuator may further have a motor and various configurations for vertically moving the first link arm 1440. In the present disclosure, the type of actuator is not limited, and various actuators may be adopted, as necessary. Two first link arms 144 may be installed in parallel to disperse a load.

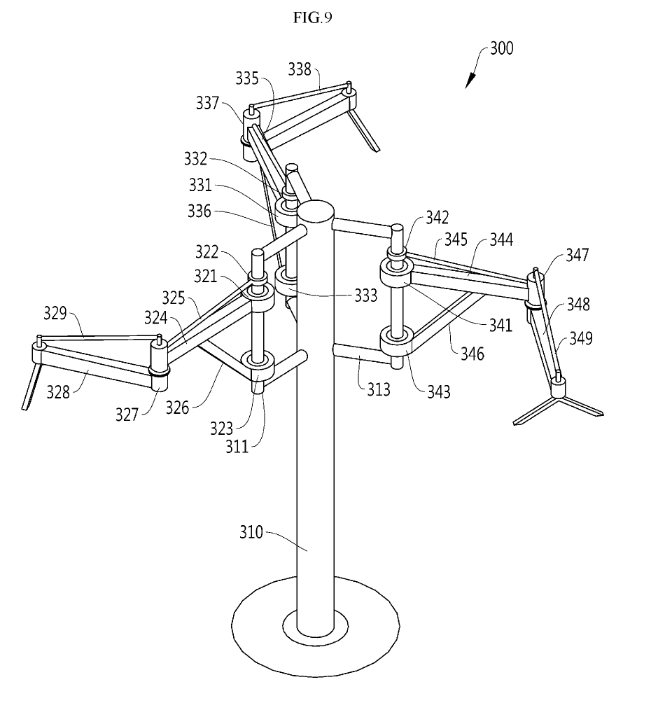

FIGS. 1 to 4 illustrate that the first axis is formed on the center support 110, but as another example, the first axis may be on an axis of the outer support 311, as illustrated in FIG. 9. In this way, it is possible to increase a movement radius and a movement area of the patient. The details will be described in detail with reference to FIG. 9 to be described below.

### Second Exemplary Embodiment

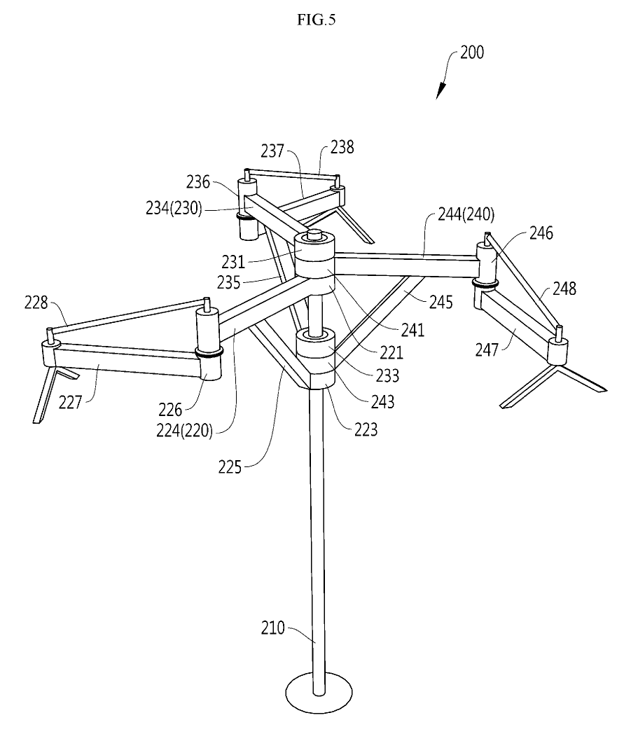

As illustrated in FIGS. 5 to 8, a multidirectional suspension device 200 for walking exercises of a patient according to a second exemplary embodiment of the present disclosure has the suspension devices 100 which have been described in the first exemplary embodiment and are provided in three directions, respectively, about the center support 210, such that three patients may simultaneously perform walking exercises. However, the number of provided suspension devices may vary depending on an installation environment, and at least two suspension devices 200 may be simultaneously installed.

As illustrated in FIG. 5, the multidirectional suspension device 200 for walking exercises of a patient includes a first suspension device part 220 in a first direction, a second suspension device part 230 in a second direction, and a third suspension device part 240 in a third direction. In this case, the first, second, and third directions are configured such that an interior angle between the first, second, and third suspension device parts 220, 230, and 240 is 120 degrees about the center support 110. However, the number of suspension device parts may be two or more, and the interior angle therebetween may vary depending on the number of suspension device parts. That is, in a case in which two suspension device parts are provided, the first and second directions are configured such that an interior angle between the two suspension device parts is 180 degrees.

The multidirectional suspension device for walking exercises of a patient according to the second exemplary embodiment of the present disclosure is identical, in terms of the function and the configuration, to the multidirectional suspension device according to the first exemplary embodiment except that the multiple suspension device parts are provided. Therefore, the description of the second exemplary embodiment is substituted with the aforementioned description of the first exemplary embodiment, and constituent elements of the second exemplary embodiment different from the constituent elements of the first exemplary embodiment will be mainly described below. As illustrated in FIG. 5, the first suspension device part 220 includes a first link unit and a second link unit. The first link unit includes a first link arm rotating unit 221, a first lower support rotating unit 223, a first link arm 224, and a first lower support 225, and the second link unit includes a link coupling unit 226, a second link arm 227, and a second upper support 228. Similar to the first suspension device part 220, each of the second and third suspension device parts 230 and 240 also includes first and link units, but there are differences in installation directions. In order to provide the suspension device parts 220, 230, and 240 in the three directions, the first link arm rotating unit 221 of the first suspension device part, the first link arm rotating unit 231 of the second suspension device part, and the first link arm rotating unit 241 of the third suspension device part are sequentially provided downward on the axis of the center support 210 (however, the order thereof may be changed, as necessary), and the first lower support rotating unit 223 of the first suspension device part, the first lower support rotating unit 233 of the second suspension device part, and the first lower support rotating unit 243 of the third suspension device part are sequentially provided downward from the first link arm rotating units 221, 231, and 241 (however, the order thereof may be changed, as necessary). Although an upper support and an upper support rotating unit of the first link unit are not illustrated in FIG. 5, the upper support and the upper support rotating unit may be provided, as necessary, to disperse the patient's load, similar to the first exemplary embodiment (see FIG. 1).

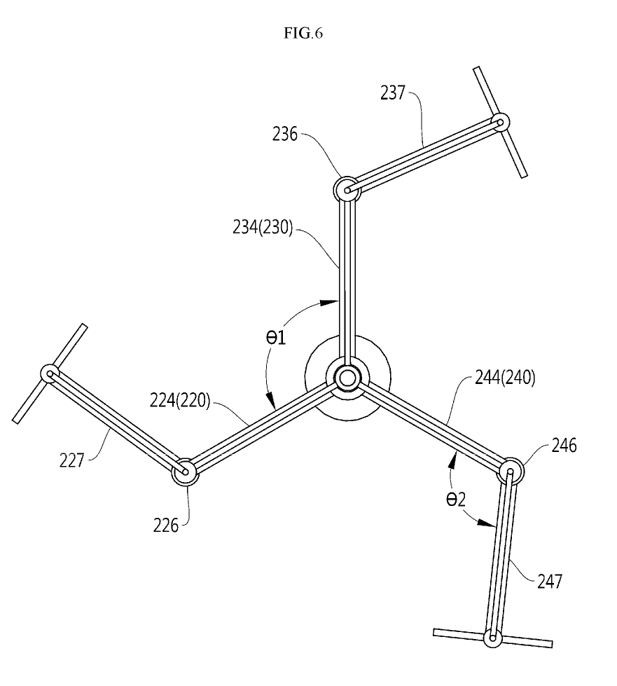

As illustrated in FIG. 6, each of the first link arm rotating units 221, 231, and 241 has a first link arm stopper (not illustrated in the drawings) so that an interior angle θ1 between the first link arms 224, 234, and 244 does not exceed 120 degrees (or the first link arms 224, 234, and 244 do not overlap or collide with one another). The first link arm stoppers restrict radii of rotation of the first link arms 224, 234, and 244. In this case, in a case in which the two suspension device parts are provided, the first link arm stoppers restrict the radii of rotation so that the interior angle θ1 between the first link arms does not exceed 180 degrees or (the arms do not overlap or collide with each other).

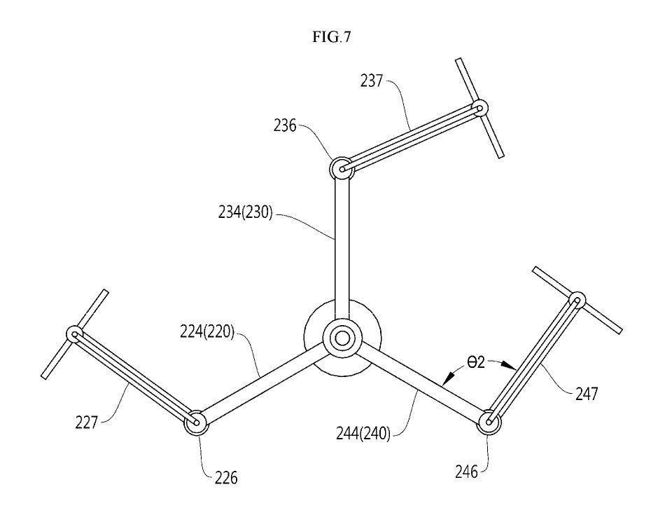

In addition, each of link coupling units 226, 236, and 246 has a second link arm stopper (not illustrated in the drawings) so that an interior angle θ2 between each of the first link arms 224, 234, and 244 and each of the second link arms 227, 237, and 247 does not exceed 180 degrees. As an example of the third suspension device part 240, the second link arm stopper prevents the second link arm 247 from being tilted toward the opposite side while exceeding the interior angle of 180 degrees, as illustrated in FIG. 7. However, the second link arm 247 may be tilted toward the opposite side, as illustrated in FIG. 7, by decoupling the second link arm stopper from the link coupling unit 246, tilting the second link arm 247 toward the opposite side, and then coupling the second link arm stopper to the link coupling unit 246 again. The same description may apply to the first and second suspension device parts 220 and 230. The first and second link arm stoppers may be provided even in the aforementioned first exemplary embodiment.

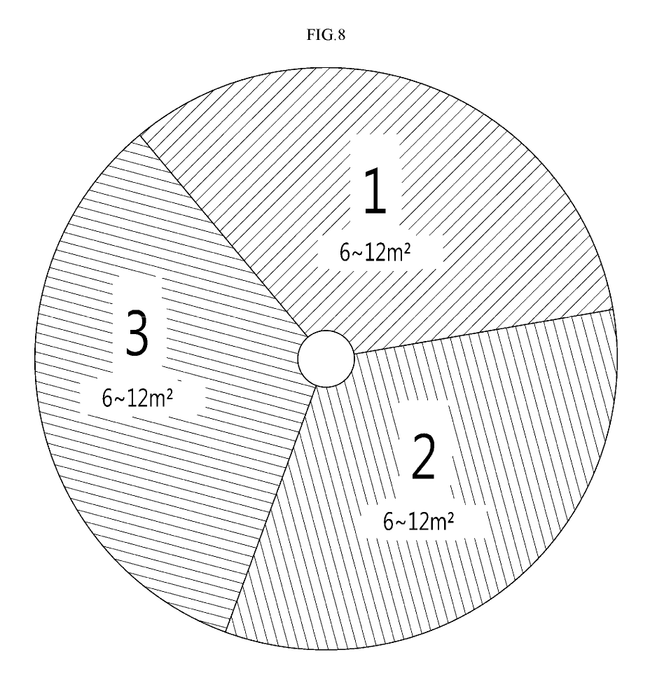

FIG. 8 illustrates patient walkable areas of the first, second, and third suspension device parts 220, 230, and 240. That is, reference number 1 in FIG. 8 indicates the patient walkable area of the first suspension device part 220, reference number 2 in FIG. 8 indicates the patient walkable area of the second suspension device part 230, and reference number 3 in FIG. 8 indicates the patient walkable area of the third suspension device part 240. The first, second, and third suspension device parts 220, 230, and 240 may be installed in the respective directions (in the first, second, and third directions), respectively, so that the respective suspension device parts have the same patient walkable area and the patients do not collide with one another while walking.

As illustrated in FIGS. 5 to 8, the rotating units 221 and 223 of the first suspension device part 220 are provided on the center support 210, such that the rotation axis of the first link arm 221 is formed on the center support 210. Therefore, the center support 210 defines the first axis, and the link coupling unit 226 defines the second axis, such that the second link arm 227 rotates about the axes. The same configuration and function may apply to the second and third suspension device parts 230 and 240.

Even in the second exemplary embodiment of the present disclosure, similar to the first exemplary embodiment, walking movement areas of the patients may be increased or decreased as the second link arms 227, 237, and 247 are slidably folded or unfolded in longitudinal directions thereof.

Meanwhile, similar to the third exemplary embodiment to be described below, each of the first link arm and the second link arm according to the second exemplary embodiment may have a curved shape. The detailed description will be substituted with the description of the third exemplary embodiment.

### Third Exemplary Embodiment

As illustrated in FIGS. 9 to 14, a multidirectional suspension device 300 for walking exercises of a patient according to a third exemplary embodiment of the present disclosure has the suspension devices 100 which have been described in the first exemplary embodiment and are provided in three directions, respectively, about the center support 210, such that three patients simultaneously perform walking exercises. However, the number of provided suspension devices may vary depending on an installation environment, and at least two suspension device parts 320, 330, and 340 may be simultaneously installed.

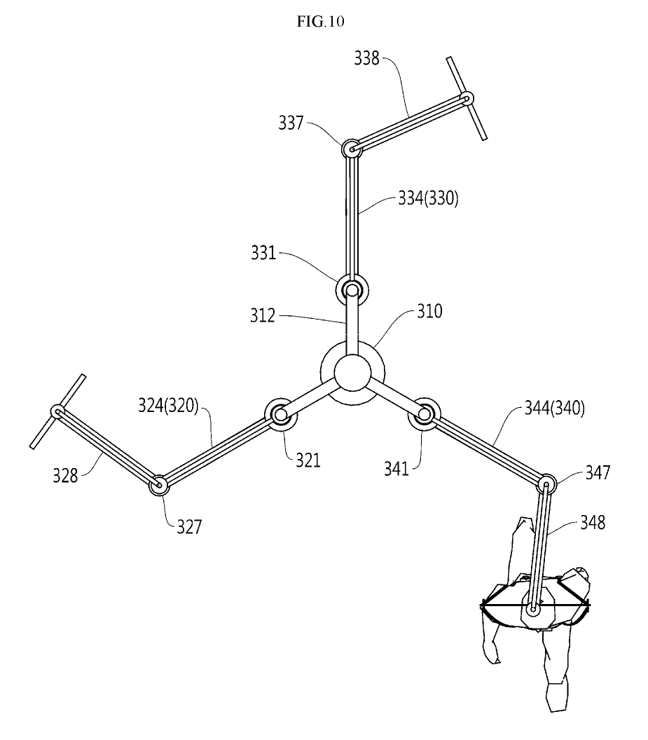

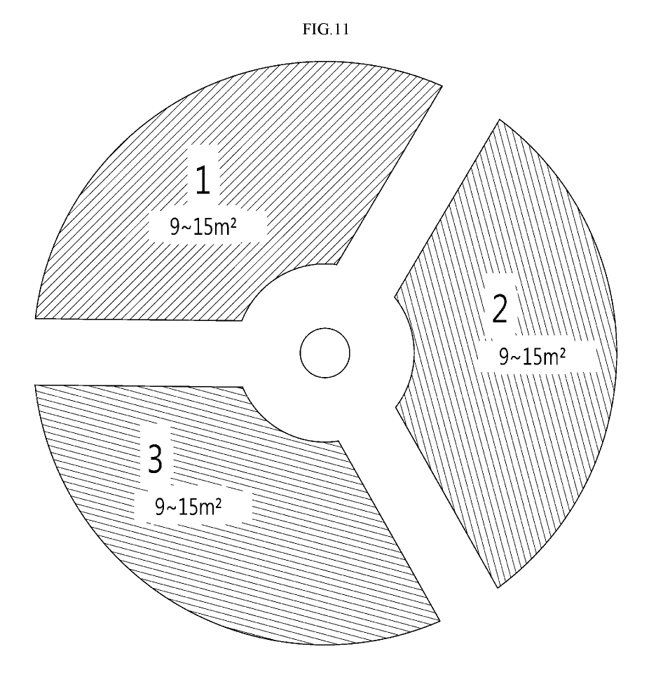

However, in comparison with the second exemplary embodiment, the multidirectional suspension device 300 for walking exercises of a patient according to the third exemplary embodiment of the present disclosure has first, second, and third outer supports 311, 312, and 313, as illustrated in FIGS. 9 and 10, such that a rotation axis (first axis) of the first link arm is not on a center support 310 but rotation axes are on outer supports 311, 312, and 313, and as a result, walking areas of the patients may be increased, as illustrated in FIG. 11, in comparison with the second exemplary embodiment (see FIG. 8). Hereinafter, differences from the first and second exemplary embodiments will be mainly described, and the descriptions of the identical configurations will be substituted with those in the first and second exemplary embodiments.

As illustrated in FIG. 9, the first, second, and third outer supports 311, 312, and 313 are provided at predetermined distances outward from the center support 310. The first, second, and third outer supports 311, 312, and 313 each have an approximately “ [symbol] ” shape, but the shape is not necessarily limited thereto. One side of the first outer support 311 is coupled to the center support 310, and the other side of the first outer support 311 is coupled to rotating units 321, 322, and 323, thereby forming rotation axes. The same configuration also applies to the second and third outer supports 312 and 313, but the second and third outer supports 312 and 313 are provided to be spaced apart from each other at 120 degrees in terms of direction. The walking area of the patients is further increased to the extent of a distance by which the first, second, and third outer supports 311, 312, and 313 are spaced apart from the center support 310.

FIG. 11 illustrates patient walkable areas of the first, second, and third suspension device parts 320, 330, and 340. That is, reference number 1 in FIG. 11 indicates the patient walkable area of the first suspension device part 320, reference number 2 in FIG. 11 indicates the patient walkable area of the second suspension device part 330, and reference number 3 in FIG. 11 indicates the patient walkable area of the third suspension device part 340. The first, second, and third suspension device parts 320, 330, and 340 may be installed in the respective directions (in the first, second, and third directions), respectively, so that the respective suspension device parts have the same patient walkable area and the patients do not collide with one another while walking. A likelihood that the patients will collide with one another is further decreased in FIG. 11 in comparison with FIG. 8.

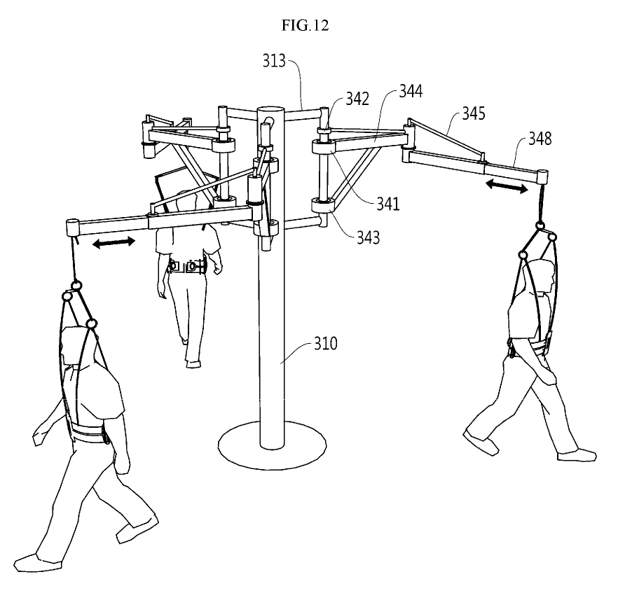

Even in the third exemplary embodiment of the present disclosure, similar to the first and second exemplary embodiments, walking movement areas of the patients may be increased or decreased as the second link arms 328, 238, 248 are slidably folded or unfolded in longitudinal directions thereof, as illustrated in FIG. 12.

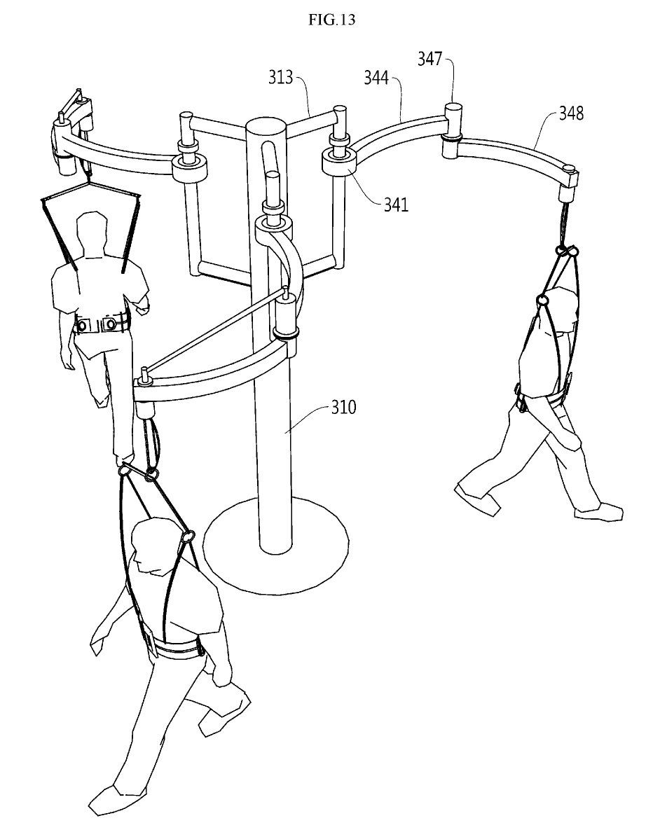

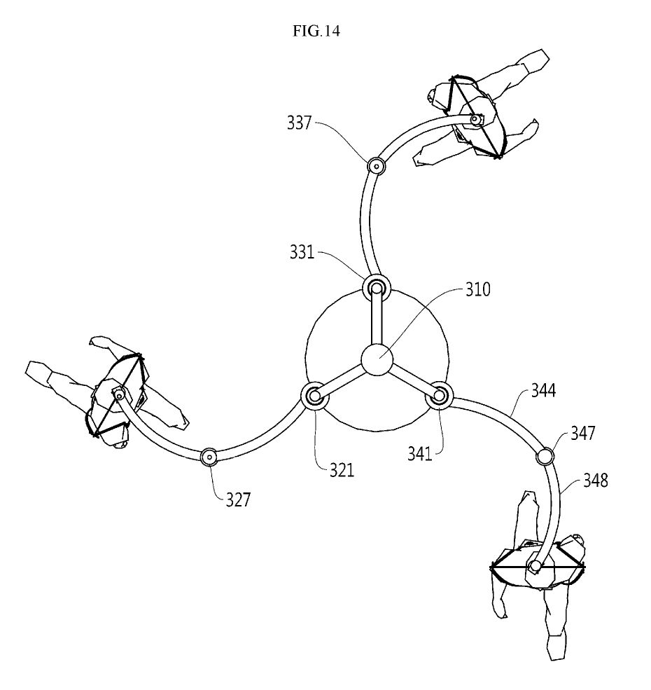

FIGS. 13 and 14 are views illustrating a state in which the first link arm and the second link arm each have a curved shape. Hereinafter, the third suspension device part will be described as an example, but the same description may apply to the first and second suspension device parts. First and second link arms 344 and 348 of the third suspension device part each have a curved shape. FIGS. 5 and 9 may contrast with the configuration in which the first and second link arms each have a straight shape. The patient may move more smoothly with lower force in the case in which the first and second link arms each have a curved shape in comparison with the case in which the first and second link arms each have a straight shape. That is, when the patient performs walking exercises, the first link arm rotates about the first axis and the second link arm rotates about the second axis, and therefore, in this case, it is important that the first axis and the second axis simultaneously move in accordance with the motion of the patient. Therefore, in comparison with the straight link arm, a distance between the patient and the first axis is decreased in the case in which the first and second link arms 244 and 248 each have a curved shape, such that the patient may move more smoothly with lower force.

In addition, although not illustrated in the drawings, the direction in which the first link arm 344 is curved and the direction in which the second link arm 248 is curved may be changed reversely. That is, the curved directions may be changed reversely as a central axis of the curved shape of the first link arm 344 is positioned at the left side and a central axis of the curved shape of the second link arm 248 is positioned at the right side. In this way, the patient may easily move with lower force in comparison with the case in which the first and second link arms are curved in the same direction.

### Fourth Exemplary Embodiment

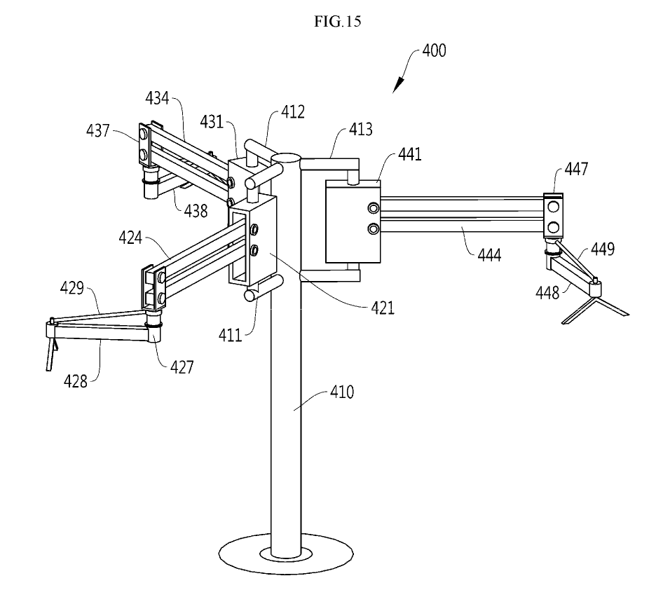

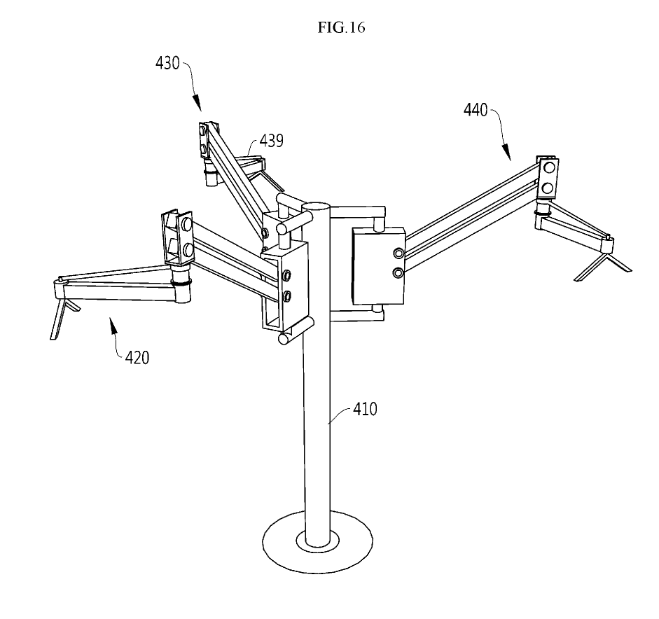

As illustrated in FIGS. 15 and 16, a multidirectional suspension device 400 for walking exercises of a patient according to a fourth exemplary embodiment of the present disclosure has the suspension devices 100 which have been described in the first exemplary embodiment and are provided in three directions, respectively, about the center support 410, such that three patients simultaneously perform walking exercises. However, the number of provided suspension devices may vary depending on an installation environment, and at least two suspension device parts 420, 430, and 440 may be simultaneously installed.

In comparison with the third exemplary embodiment, the first link arm rotating unit is not provided and first link arm vertical drive units 421, 431, 441 are provided in the fourth exemplary embodiment of the present disclosure, and the same description will be substituted with the descriptions of the first, second, and third exemplary embodiments. Hereinafter, the first suspension device part 420 will be described, but the second and third suspension device parts 430 and 440 are identical to the first suspension device part 420 except that the first suspension device part 420 is different only in terms of an installation direction from the second and third suspension device parts 430 and 440. The first suspension device part 420 has a first link unit and a second link unit, the first link unit includes a first link arm vertical drive unit 421 and a second link arm 424, and the second link unit includes a link coupling unit 427, a second link arm 428, and a second upper support 429.

The first link arm vertical drive unit 421 is coupled to a first outer support 411 and vertically moves the first link arm 424, thereby raising or lowering the patient wearing the safety belt 10 for the suspension device, as illustrated in FIG. 16. However, FIG. 16 illustrates that all of the first link arms of the first, second, and third suspension device parts are raised, but the respective first link arms may operate independently of one another. As illustrated in FIG. 15, the first link arms 424 are configured as two link arms vertically disposed in parallel. However, the number of provided first link arms may be one or more, as necessary. The first link arm 424 is coupled and fastened to the link coupling unit 427 and the first link arm vertical drive unit 421, and as illustrated in FIG. 16, the first link arm 424 is coupled to be rotated about an axis so that the first link arm 424 is freely and vertically moved when the first link arm 424 is coupled and fastened to the link coupling unit 427 and the first link arm vertical drive unit 421.

An upper end portion of the link coupling unit 427 is coupled to the first link arm 424, and a lower end portion of the link coupling unit 427 is coupled to the second link arm 428 so that the second link arm 428 rotates about the second axis. The second upper support 429 serves to disperse a load applied to the second link arm 428, and the second upper support 429 is coupled to an end portion of the second link arm 428 and the link coupling unit 427. The second upper support 429 may be coupled to the link coupling unit 427 so that the second upper support 429 may rotate about an axis or a portion of the second upper support 429, which is coupled to the end portion of the second link arm 428, may rotate about an axis.

In this case, similar to the aforementioned third exemplary embodiment, the second link arm 428 may be formed to have a curved shape.

According to the aforementioned first, second, third, and fourth exemplary embodiments, the first link arm drive unit may be implemented as the first link arm rotating unit or the first link arm vertical drive unit, as necessary. In addition, the body of the first link arm rotating unit may be formed integrally with the first link arm and implemented to include therein a rotating means such as a bearing.

<Installation Method>

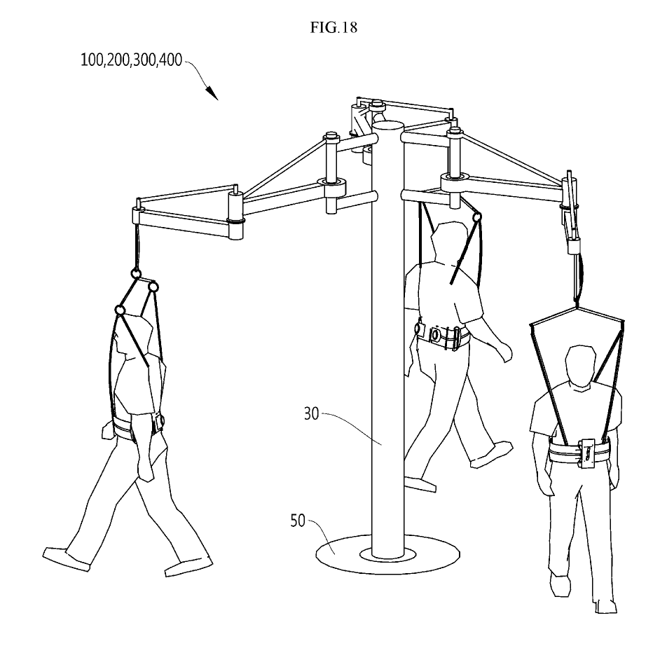

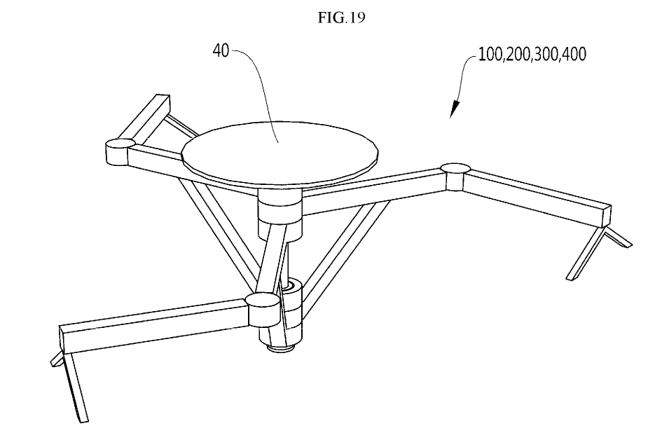

As illustrated in FIGS. 17 to 19, the multidirectional suspension devices 100, 200, 300, and 400 for walking exercises of a patient are fixed to a ceiling or a floor based on the center support 30. That is, FIG. 17 illustrates that each of the multidirectional suspension devices 100, 200, 300, and 400 for walking exercises of a patient is fixed to the ceiling by an upper support plate 40 and fixed to the floor by a lower support plate 50. FIG. 18 illustrates that each of the multidirectional suspension devices is fixed only to the floor without being fixed to the ceiling, and FIG. 19 illustrates that each of the multidirectional suspension devices is fixed only to the ceiling without being fixed to the floor. Since the multidirectional suspension device is fixed to the ceiling and the floor, an installation space may be small and the installation may be simply performed, and a space may be more efficiently utilized because there is no unnecessary structure in a lower space of each of the multidirectional suspension devices 100, 200, 300, and 400 for walking exercises of a patient.

While the aforementioned configurations and functions of the respective constituent elements have been separately described for convenience of description, any one of the configurations and functions may be implemented by being incorporated into other constituent elements or subdivided, as necessary.

While the exemplary embodiment of the present disclosure has been described above, the present disclosure is not limited thereto and may be variously changed and modified. That is, those skilled in the art may readily understand that various modifications may be made without departing from the subject matter of the present disclosure. In addition, it should be noted that the specific descriptions of publicly known functions and configurations related to the present disclosure or of coupling relationships among the configurations of the present disclosure will be omitted when it is determined that the specific descriptions may unnecessarily obscure the subject matter of the present disclosure.

The present disclosure may be used to enable a patient to perform walking exercises.

1. A multidirectional suspension device for walking exercises, comprising:
a center support;
a first link unit which is coupled to the center support and rotated about a first axis or vertically moved; and
a second link unit which is linked with the first link unit, rotates about a second axis or slides in a longitudinal direction thereof, and has one side to which a safety belt for the suspension device worn by a user is coupled,
wherein the user is suspended from the multidirectional suspension device and performs exercises in multiple directions by the first axis and the second axis.

2. The multidirectional suspension device of claim 1, wherein the first axis is a central axis of the center support, and the second axis is a coupling axis between the first link unit and the second link unit.

3. The multidirectional suspension device of claim 2, wherein the first link unit includes:
a first link arm drive unit which is provided on the center support and rotates the first link arm about the first axis or vertically moves the first link arm; and
a first link arm which is coupled at one side thereof to the first link arm drive unit,
the second link unit includes:
a link coupling unit which is coupled at the other side to the first link arm; and
a second link arm which is coupled to be rotatable relative to the link coupling unit, and
the safety belt for the suspension device is coupled to an end portion of the second link arm.

4. The multidirectional suspension device of claim 3, wherein the first link arm or the second link arm is slidably folded or unfolded in a longitudinal direction thereof.

5. The multidirectional suspension device of claim 3, wherein the first link unit further includes a first link arm stopper which is provided on the first link arm drive unit and restricts a rotation angle of the first link arm.

6. The multidirectional suspension device of claim 3, wherein the second link unit further includes a second link arm stopper which is provided on the link coupling unit and restricts a rotation angle of the second link arm.

7. The multidirectional suspension device of claim 6, wherein the second link arm stopper restricts an interior angle between the first link arm and the second link arm so that the interior angle does not exceed 180 degrees.

8. The multidirectional suspension device of claim 3, wherein the first link arm or the second link arm is formed in a straight shape when the first link arm drive unit vertically moves the first link arm, and the first link arm or the second link arm is formed in a curved shape when the first link arm drive unit rotates the first link arm.

9. The multidirectional suspension device of claim 8, wherein a central axis of the curved shape of the first link arm and a central axis of the curved shape of the second link arm are formed on the same plane or different planes.

10. The multidirectional suspension device of claim 3, wherein the first link unit further includes an upper support or a lower support for dispersing a user's load applied to the first link arm, and the second link unit further includes an upper support for dispersing a user's load applied to the second link arm.

11. The multidirectional suspension device of claim 1, wherein the first axis is spaced apart from a central axis of the center support at a predetermined distance, and the second axis is a coupling axis between the first link unit and the second link unit.

12. The multidirectional suspension device of claim 11, further comprising:
an outer support which is coupled to be spaced apart from the center support at a predetermined distance in a circumferential direction,
wherein the first link unit includes:
a first link arm drive unit which is provided on the outer support and rotates the first link arm about the first axis or vertically moves the first link arm; and
a first link arm which is coupled at one side thereof to the first link arm drive unit,
the second link unit includes:
a link coupling unit which is coupled at the other side to the first link arm; and
a second link arm which is coupled to be rotatable relative to the link coupling unit, and
the safety belt for the suspension device is coupled to an end portion of the second link arm.

13. The multidirectional suspension device of claim 12, wherein the first link arm or the second link arm is slidably folded or unfolded in a longitudinal direction thereof.

14. The multidirectional suspension device of claim 12, wherein the first link unit further includes a first link arm stopper which is provided on the first link arm drive unit and restricts a rotation angle of the first link arm.

15. The multidirectional suspension device of claim 12, wherein the second link unit further includes a second link arm stopper which is provided on the link coupling unit and restricts a rotation angle of the second link arm.

16. The multidirectional suspension device of claim 15, wherein the second link arm stopper restricts an interior angle between the first link arm and the second link arm so that the interior angle does not exceed 180 degrees.

17. The multidirectional suspension device of claim 12, wherein the first link arm or the second link arm is formed in a straight shape when the first link arm drive unit vertically moves the first link arm, and the first link arm or the second link arm is formed in a curved shape when the first link arm drive unit rotates the first link arm.

18. The multidirectional suspension device of claim 17, wherein a central axis of the curved shape of the first link arm and a central axis of the curved shape of the second link arm are formed on the same plane or different planes.

19. The multidirectional suspension device of claim 12, wherein the first link unit further includes an upper support or a lower support for dispersing a user's load applied to the first link arm, and the second link unit further includes an upper support for dispersing the user's load applied to the second link arm.

20. The multidirectional suspension device of claim 1, comprising:
a first suspension device which includes the first link unit and the second link unit and is provided in a first direction; and
a second suspension device which is provided in a second direction different from the first direction, wherein multiple users simultaneously perform walking exercises.

21. (canceled)
